(19) United States
(12) Patent Application Publication
(10) Pub. No.: US 2019/0303790 A1
(43) Pub. Date: Oct. 3, 2019

(54) PROOF OF WORK BASED ON TRAINING OF MACHINE LEARNING MODELS FOR BLOCKCHAIN NETWORKS

(71) Applicant: Oben, Inc., Pasadena, CA (US)

(72) Inventors: Mark Joseph Harvilla, Pasadena, CA (US); Patrick Gerzanics, Algonquin, IL (US); Marius Sebastian Rusu, Tirgu Mures (RO); Jascha Wanger, Pasadena, CA (US)

(21) Appl. No.: 16/364,998

(22) Filed: Mar. 26, 2019

Related U.S. Application Data
(60) Provisional application No. 62/648,849, filed on Mar. 27, 2018.

(51) Int. Cl. G06N 20/00; G06F 16/27

(52) U.S. Cl. CPC G06N 20/00; G06Q 20/065; G06F 16/27

(57) ABSTRACT

A system and a method are disclosed for receiving, by a processor, a request from a client device, and, in response to receiving the request, transmitting a machine learning model and training data to the client device. The processor receives a trained version of the machine learning model, where a nonce is generated as a byproduct of the trained version, the nonce being at least a part of a candidate value for a new block being added to a blockchain. In response to receiving the trained version, the processor determines whether the trained version of the machine learning model satisfies an acceptance criterion. In response to determining that the trained version of the machine learning model satisfies the acceptance criterion, the processor causes release of a token to a user of the client device.

### CROSS-REFERENCE TO RELATED APPLICATIONS

This application claims the benefit of U.S. Provisional Patent Application No. 62/648,849, filed Mar. 27, 2018, the disclosure of which is hereby incorporated by reference herein in its entirety.

### BACKGROUND

This invention relates in general to the mining process used by blockchain networks, and more specifically to blockchain networks using Proof of Work (PoW) based on training of machine learning based models.

Miners of crypto-currencies validate transactions by guessing numbers (“nonces”) in the hopes of finding a number whose hash, in combination with other transaction related data, is below a target level set by a difficulty parameter. The mining process consumes a very large amount of electricity. For example, it is estimated that the power usage of the Bitcoin network consumes several hundred KWh (kilo watt hours) of energy per transaction. The amount of energy used by the Bitcoin network exceeds the power usage of several countries, for example, countries as large as Ireland. Furthermore, if energy that causes pollution, for example, coal-fired power plants are used for the powering the process, the energy consumption also causes pollution leading to environmental concerns. Accordingly, a huge amount of energy is wasted for generating numeric values that have no use other than validation of transactions. Conventional PoW-based crypto-currency technologies therefore cause a huge amount of electricity to be wasted.

### SUMMARY

Systems and methods are disclosed herein for implementing a coordinator system that delegates tasks for training machine learning models to computing devices. When the computing devices successfully complete the tasks, a token that corresponds to the task may be released to the computing devices; when the computing devices are not successful, the token may be withheld from release. Further, as a byproduct of completing the task (e.g., an error value calculated for the trained machine learning model), a nonce may be generated. The nonce may be packed into a valid candidate block, which may be distributed to the computing devices (e.g., that make up the distributed network hosting the blockchain) for use in attempting to add a new block to the blockchain, which may yield a so-called block reward in the form of, e.g., a coinbase transaction.

In some embodiments, determining whether the computing devices successfully have completed the tasks involves determining whether the trained version of the machine learning model satisfies the acceptance criterion. To this end, a processor may determine a measure of accuracy of the completed task, e.g., by predicting results from a labelled dataset. The processor may determine a first aggregate value based on the predicted results. The processor may also determine a second aggregate value based on results of the trained version of the machine learning model. The processor may then determine, as a measure of accuracy, an error value based on a difference between the first aggregate value and the second aggregate value, and determine that the trained version of the machine learning model satisfies the acceptance criterion based on whether the error value is less than an error threshold value.

In some embodiments, the coordinator system assigns tasks to train additional machine learning models using additional training sets based, e.g., on tasks established in a task queue. The coordinator system may be decentralized, and management of the tasks may be enforced by distributed data structures.

### BRIEF DESCRIPTION OF THE DRAWINGS

The features and advantages described in the following detailed description are not all-inclusive. Many additional features and advantages will be apparent to one of ordinary skill in the art in view of the drawings, specification, and claims hereof.

Figure (FIG. 1 is a diagram of a system environment illustrating a blockchain network using proof of work based on training of machine learning based models, in accordance with an embodiment of the invention.

FIG. 2 is a diagram of system architecture of a computing device of the blockchain network, in accordance with an embodiment of the invention.

FIG. 3 is a diagram of system architecture of a coordinator system, in accordance with an embodiment of the invention.

FIG. 4 is a diagram of a training task, in accordance with an embodiment of the invention.

FIG. 5 shows a flowchart of the process executed by a computing device for executing a task obtained from the coordinator system, according to an embodiment of the invention.

FIG. 6 shows a flowchart of the process executed by a computing device for adding a block to a blockchain, according to an embodiment of the invention.

FIG. 7 shows a flowchart of a process executed by a coordinator system, according to an embodiment of the invention.

FIG. 8 shows a flowchart of an additional process executed by a coordinator system, according to an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

Embodiments utilize processing resources of crypto-currency miners for performing valuable computation. For example, the processing resources of crypto-currency miners are used to train machine learning based models. Accordingly, computing devices participating in a blockchain network generate a nonce that is a numeric value associated with training of a machine learning based model.

System Environment

Figure (FIG. 1 is a diagram of a system environment illustrating a blockchain network using proof of work based on training of machine learning based models, in accordance with an embodiment of the invention. The system environment comprises a blockchain network 110 of computing devices 100, one or more coordinator systems 120, and one or more task provider systems 130. Some embodiments of the computing devices 110, coordinator system 120, and task provider systems 130 have different and/or other modules than the ones described herein, and the functions can be distributed among the modules in a different manner than described here.

FIG. 1 and the other figures use like reference numerals to identify like elements. A letter after a reference numeral, such as “100A,” indicates that the text refers specifically to the element having that particular reference numeral. A reference numeral in the text without a following letter, such as “100,” refers to any or all of the elements in the figures bearing that reference numeral (e.g. “100” in the text refers to reference numerals “100A” and/or “100N” in the figures).

The blockchain network 110 comprises a plurality of computing devices 100. A miner is a computing device 100 that demonstrates proof of work for new blocks to be added to the blockchain. Conventional blockchains demonstrate proof of work by repeated hashing to find a nonce for a new block to be added to the blockchain. A nonce is a field in the block whose value is set so that the hash of the block satisfies certain predefined criterion, for example, the hash must have a run of leading zeros of a predetermined size. Conventional techniques for generating nonces spend huge processing resources for generating values that have no other use than to add a block to the blockchain.

Embodiments generate nonces based on useful work that is performed by computing devices rather than repeated hashing, thereby using the processing resources of the miners to perform tasks that have value other than just adding a block to the blockchain. For example, the tasks comprise training of machine learning models. In an embodiment, the tasks represent training of machine learning models associated with personal Artificial Intelligence.

In an embodiment, the nonce is based on numerical byproduct value(s) generated as a result of training the machine learning model, for example, a measure of accuracy of the training model. An example of measure of accuracy used is an error metric representing an aggregate error of the results of the trained machine learning model obtained by predicting results from a labelled dataset and comparing the predicted results with known results. Examples of error metrics for machine learning models used by embodiments include r-squared error, mean squared error, F-score, cross entropy, KL divergence, and so on. A computing device 100 of the blockchain network 110 uses the numeric value of the error metric as the nonce. In some embodiments, the computing device 100 determines the nonce value based on weights of the model, for example, by determining an aggregate value based on one or more weights of the model. For example, the computing device 100 may determine the nonce as the sum of all weights, an average of all weights, or a hash value based on the weights.

The computing device 100 comprises a task processing module 125 and a block store 145. In an embodiment, the block store 145 stores a set of blocks, each block comprising a plurality of records. The block store 145 is replicated across computing devices of the blockchain network 110. The block store 145 is also referred to as a ledger that stores information including transactions, for example, transactions describing transfer of cryptocurrency from one user account to another.

The coordinator system 120 comprises a task queue 150 and a result verification module 160. The task queue 150 comprises training tasks 155. The task provider systems 130 provide tasks to a coordinator system 120 for adding to the task queue 150. In an embodiment, the task provider system 130 generates tasks for training machine learning models and provides the tasks comprising details of the machine learning model to be trained and the training data. The task provider system 130 also associates the provided task with a stake (interchangeably used with the word “token” herein) representing a compensation to the computing device 100 that trains the model to an acceptable level. In an embodiment, a user account associated with the task provider system deposits some amount in a financial account for providing to a user account associated with the computing device 100 that provides the winning nonce.

The computing device 100 that completes the training of the model and provides the results is provided the compensation if the trained model is determined to satisfy an acceptance criteria. A user associated with the computing device 100 that completes a task of training a machine learning model also receives a chance at earning cryptocurrency since a numerical value associated with the trained model is used as a nonce. If a hash value generated by adding the nonce to a block satisfies a predetermined criteria, for example, if the hash value has a leading run of zeros, a user account associated with the computing device that provided the nonce is compensated with a predetermined amount of cryptocurrency.

In an embodiment, a computing device 100 is given the chance to be considered for being compensated based on the value of nonce independent of whether the model trained by the computing device is determined to be acceptable. Accordingly, a computing device 100 could potentially provide a nonce that generates the winning hash value, thereby receiving cryptocurrency but still not receive the stake associated with the task if the trained model is determined to be unacceptable by the provider system 130.

The coordinator system 120 provides the training tasks to computing devices 100. The task processing module 125 of the computing device 100 performs the processing associated with a training task 155 received from the coordinator system 120. The computing device 100 provides the result of performing the training task 155 to the coordinator system 120. The result verification module 160 performs the verification of the result to determine whether the result is an acceptable result. In an embodiment, the result verification module 160 comprises a user interface that presents the results to a user for manual verification of the result. In an embodiment, a computing device 100 is allowed to execute a task only once, thereby preventing a computing device to repeatedly execute the same task in an attempt to get multiple opportunities to provide a nonce without performing useful work.

The computing devices 100 can be a personal computer (PC), a desktop computer, a laptop computer, a notebook, a tablet PC executing an operating system, for example, a Microsoft Windows®-compatible operating system (OS), macOS®, and/or a Linux distribution. In another embodiment, the computing device 100 can be any device having computer functionality, such as a personal digital assistant (PDA), mobile telephone, smartphone, wearable device, etc.

The interactions between a computing device 100 and other computing devices are typically performed via a network, for example, via the Internet. The network enables communications between various processors. In one embodiment, the network uses standard communications technologies and/or protocols. The data exchanged over the network can be represented using technologies and/or formats including the hypertext markup language (HTML), the extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above.

System Architecture

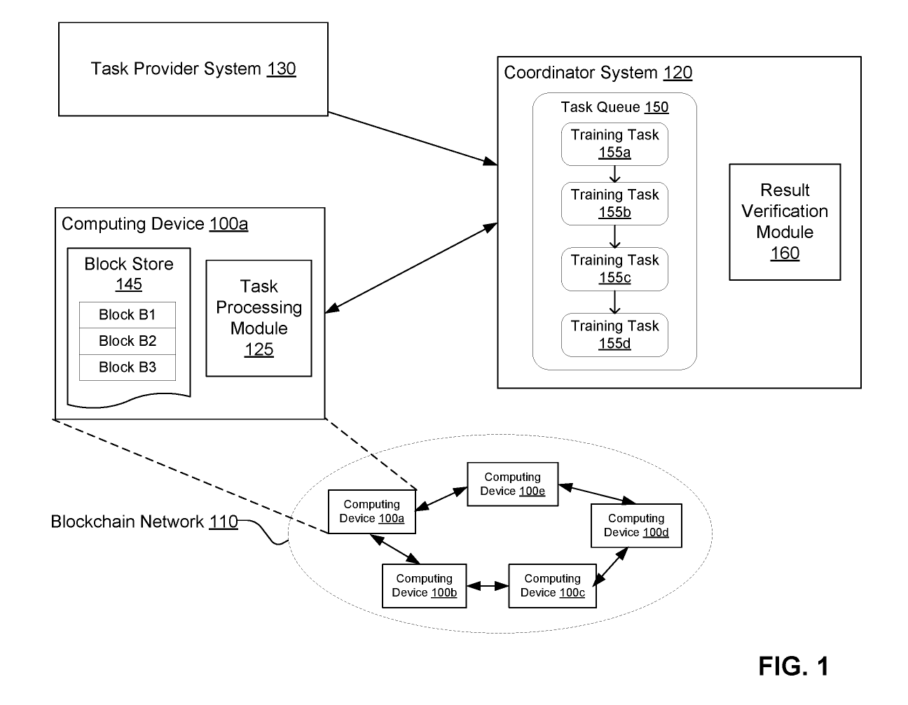

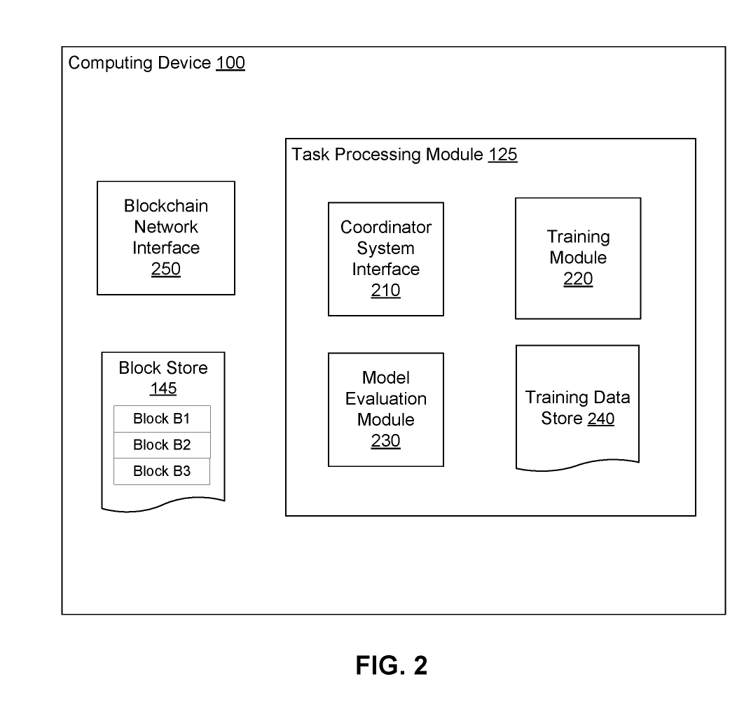

FIG. 2 is a diagram of system architecture of a computing device of the blockchain network, in accordance with an embodiment of the invention. The computing device 100 comprises a blockchain network interface 250, a block store 145, and a task processing module 125. In other embodiments, the computing devices 100 may include additional, fewer, or different modules. Conventional components such as network interfaces, security mechanisms, load balancers, failover servers, management and network operations consoles, and the like are not shown so as to not obscure the details of the system.

The computing devices 100 that are part of the blockchain network 110 include a block store 145 that comprises a plurality of records. The block store 145 is replicated across computing devices of the blockchain network 110. The blockchain network interface 250 performs interactions related to the blockchain protocol, for example, performing replication of the data stored in the block store 145. The block store 145 is also referred to as a ledger that stores information including transactions, for example, transactions describing transfer of any entity from one user to another. Examples of entities transferred include values representing an amount of a cryptocurrency, for example, bitcoin.

The task processing module 125 performs processing of tasks received from the coordinator system 120. The task processing module 125 comprises modules including a coordinator system interface 210, a training module 220, a model evaluation module 230, and a training data store 240. In other embodiments, the task processing module 125 may include additional, fewer, or different modules than those shown in FIG. 2.

The coordinator system interface 210 module performs interactions with the coordinator system 120 to request and receive tasks from the coordinator system 120. In an embodiment, a task received comprises information describing a machine learning model and training data for training the machine learning model. The coordinator system interface 210 stores the received training data in the training data store 240. The training module 220 trains the received machine learning model using the training data provided with the task.

The model evaluation module 230 evaluates the machine learning model to determine whether the machine learning model has been trained to a sufficient level. In an embodiment, the model evaluation module 230 predicts results for a set of test data based on known results from existing tests and determines an aggregate value based on the predicted results. The model evaluation module 230 also determines a corresponding aggregate value based on the known results from the existing tests for the set of tests. The model evaluation module 230 determines an error value based on a difference between the aggregate predicted result value and the aggregate known result value. The model evaluation module 230 determines that the machine learning model is sufficiently trained if the computed error value is less than an error threshold value associated with the task.

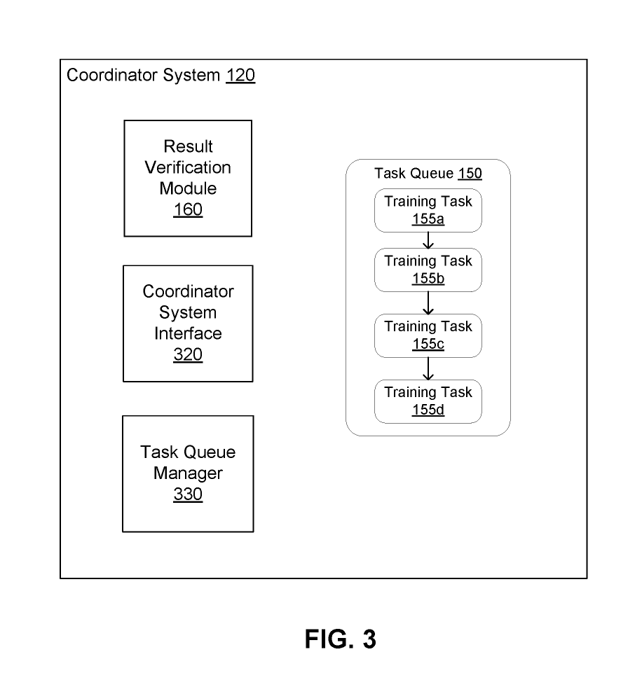

FIG. 3 is a diagram of system architecture of a coordinator system, in accordance with an embodiment of the invention. The coordinator system 120 includes a result verification module 160, a coordinator system interface 320, a task queue manager 330, and a task queue 150. In other embodiments, the coordinator system 120 may include additional, fewer, or different modules than those shown in FIG. 3.

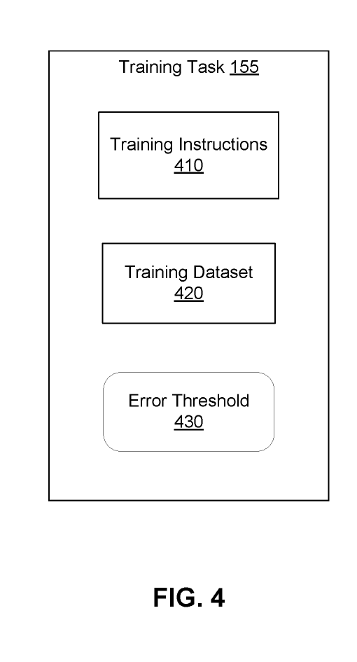

The task queue 150 includes one or more tasks, for example, training tasks 155. The tasks in the task queue 150 may be received from one or more task provider systems 130. The details of a training task are described in connection with FIG. 4. The task queue manager 330 manages the task queue 150 by performing operations related to the task queue 150, for example, adding a task 155 to the task queue 150 or deleting a task from the task queue 150.

The coordinator system interface 320 allows systems such as task provider system 130 or computing devices 100 to interact with the task queue 150. In an embodiment, the coordinator system interface 320 provides application programming interfaces (APIs) for remotely interacting with the task queue 150. For example, the task provider system 130 may invoke a task submission API to add a task to the task queue 150. As another example, a computing device 100 may invoke a task retrieval API for accessing a task from the task queue 150 for processing. The computing device 100 may further invoke a result submission API for submitting a result of training a machine learning model to the coordinator system 120.

The result verification module 160 determines whether a computing device 100 successfully completed a task retrieved from the task queue 150. In an embodiment, the result verification module 160 verifies the results of training a machine learning model submitted by a computing device 110. For example, the result verification module 160 may select a set of tests having known results and execute the trained model to determine an aggregate measure indicating a degree to which the results predicted by the trained model match the corresponding known results.

FIG. 4 is a diagram of a training task, in accordance with an embodiment of the invention. The training task 155 includes training instructions 410, training dataset 420, and an error threshold 430. In other embodiments, the training task 155 may include additional, fewer, or different components than those shown in FIG. 4. The training dataset 420 is the dataset for use in training a machine learning model. The training instructions 410 specify details of how the training of the machine learning model should be performed. The error threshold 430 provides a metric for evaluating the trained model to determine whether the model has been trained to a sufficient level or needs further training.

Processes

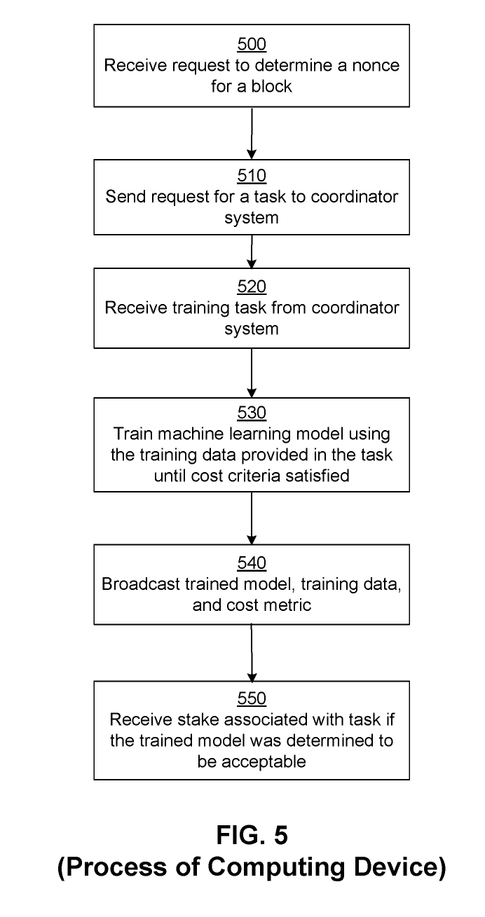

FIG. 5 shows a flowchart of the process executed by a computing device for executing a task obtained from the coordinator system, according to an embodiment of the invention. A computing device 100 receives 500 a request to determine a nonce for a block being added to the block store 145 of the blockchain network 110. The task processing module 125 sends 510 a request for a task to the coordinator system 120. The task processing module 125 receives 520 a training task 155 from the coordinator system 120. The training task comprises training data for training a machine learning model. The task processing module 125 trains 530 the machine learning model using the training data provided in the received training task until a cost criteria based on the error threshold provided in the training task is satisfied.

The blockchain network interface 250 of the computing device 100 broadcasts 540 the trained model, the training data, and the cost metric value obtained from the trained model. The computing device 100 also provides the trained model to the coordinator system 120. The coordinator system 120 evaluates the trained model. In an embodiment, the coordinator system 120 provides a user interface to users of the task provider system 130 allowing them to validate the trained model and determine whether the model is trained to a satisfactory level. If the users of the task provider system 130 approve the trained model by indicating that the model is trained to a satisfactory level, the users of the computing device are provided the stake associated with the training task. The computing device 100 receives 550 the stake associated with task if the trained model was determined to be acceptable.

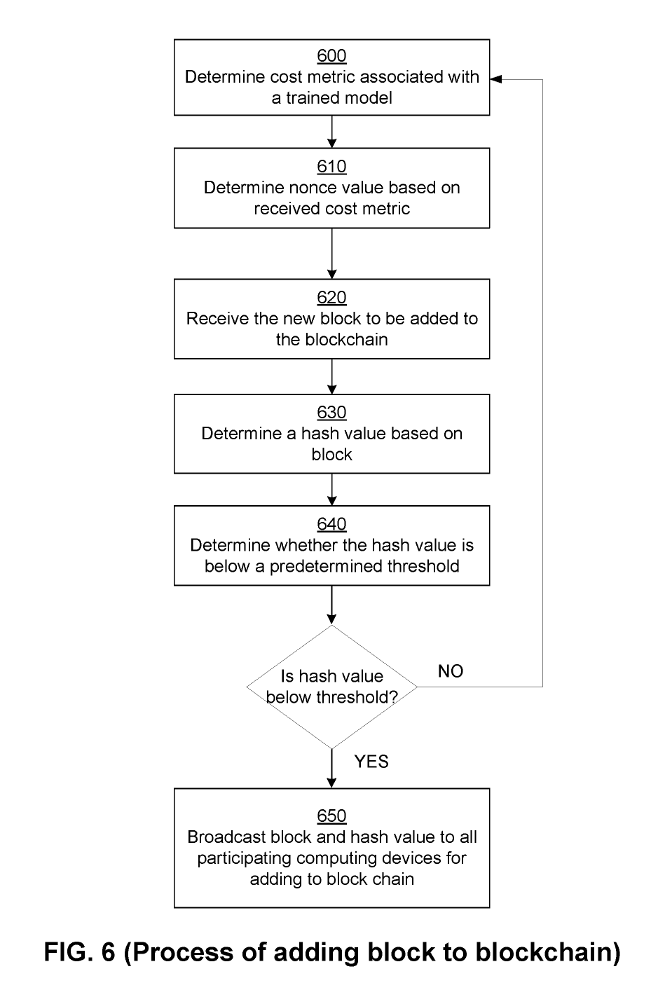

FIG. 6 shows a flowchart of the process executed by a computing device for adding a block to a blockchain, according to an embodiment of the invention. A computing device 100 receives 600 a cost metric associated with a trained model, for example the error metric of the trained model based on a training dataset. The computing device 100 determines the nonce value based on the received cost metric. For example, the computing device 100 may use the numeric value of the error metric as the nonce value. The computing device 100 receives 620 the new block to be added to the blockchain. The computing device 100 modifies the block by adding the nonce to the block and determines 630 a hash value based on the modified block. The computing device 100 determines 640 whether the generated hash value satisfies a predetermined criteria, for example, whether the hash value is below a predetermined threshold. If the computing device 100 determines that the generated hash value is below the predetermined threshold value, the computing device broadcasts 650 the block to all participating computing devices of the blockchain network 110 for adding to the blockchain. If the computing device 100 determines that the generated hash value is not below the predetermined threshold value, however, then the process begins anew, where either the model is retrained and a cost metric is determined 600 by the computing device for the model, or a new model is received by the computing device and trained to determine 600 the cost metric. The process described in FIG. 6 may be executed by a computing device or any other system, for example, the coordinator system 120.

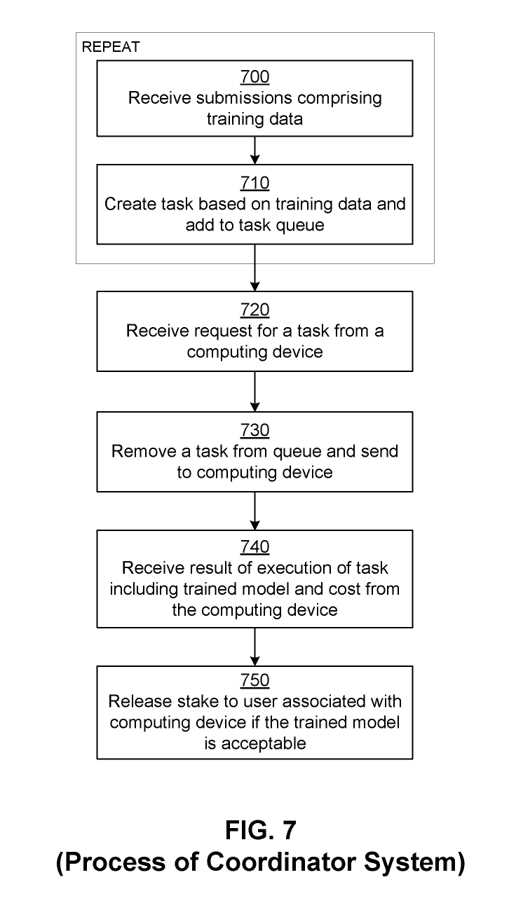

FIG. 7 shows a flowchart of the process executed by a coordinator system, according to an embodiment of the invention. The coordinator system 120 receives 700 submissions from task provider systems 130. The received tasks comprise training datasets for training machine learning models. In an embodiment, the task provider system 130 further associates the task with a stake representing a potential compensation to a computing device that performs training of the model and provides acceptable results based on certain criteria for measuring the quality of results. The coordinator system 120 creates 710 tasks based on the received training datasets and adds the tasks to the task queue 150. The steps 700 and 710 may be repeated multiple times since the coordinator system 120 may receive several tasks and add them to the task queue 150. The coordinator system 120 receives 720 a request for a task from a computing device 100. The coordinator system 120 removes 730 a task from the queue and sends the task to the computing device that sent the request. The computing device executes the task, for example, by training a machine learning model based on the training dataset in the task and sends the result of execution of the task to the coordinator system 120. Accordingly, the coordinator system 120 receives 740 the result of execution of the task including the trained model and cost metric for the trained model from the computing device. The coordinator system 120 verifies whether the trained model is acceptable.

In an embodiment, a user may review the trained model, for example, by executing it using datasets with known results and observing the quality of the generated results. If the coordinator system 120 determines that the trained model is acceptable, the coordinator system 120 releases a stake associated with the task to the computing device, for example, by providing compensation to a user account associated with the computing device.

In an embodiment, the coordinator system 120 is decentralized, such that the task submission interface, task queue manager, etc., are handled by smart contracts. A smart contract (also referred to herein as a distributed data structure) is a protocol that digitally enforces the performance of a contract. For example, the terms of the agreement between buyer and seller in a smart contract may be directly written into lines of code. The code and the agreements of the smart contract are stored in a blockchain network. Smart contracts permit trusted transactions and agreements among disparate parties without using a central authority or external enforcement mechanism. In order to be completely transparent regarding the coordinator system's implementation the systems shown in FIG. 1 may implement contracts via a smart contract. The smart contract ensures that those participating in the ecosystem are treated fairly as the code can be reviewed and validated at any time. This also would prevent any concerns about the work distribution requiring Project PAI's involvement as the contract could be done on any nodes running the smart contract VM.

The data may be submitted to the coordinator system in a homomorphically encrypted form which is irreversible without knowledge of a private key owned by the client/user. The data may be submitted to the coordinator system in an encoded form that is not readily observable. This is different from encryption in that, if the encoding process is known a priori, it can be easily reversed.

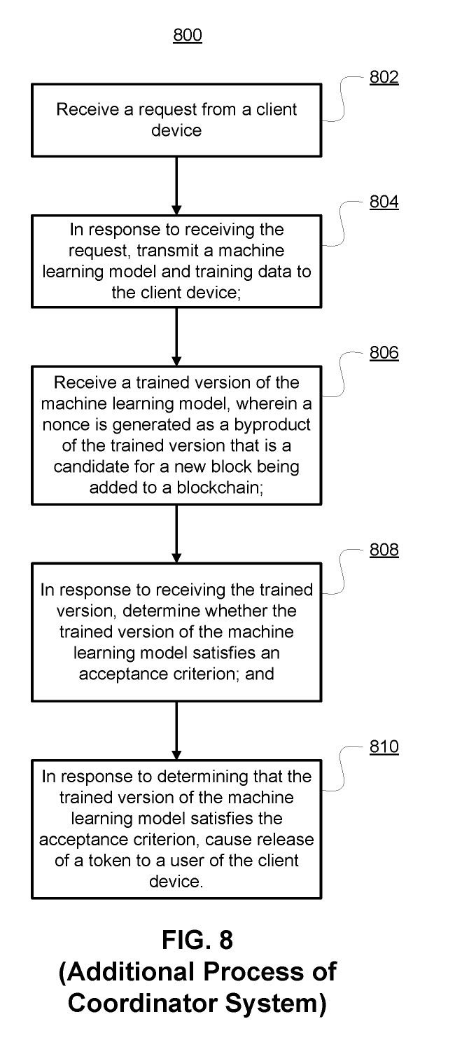

FIG. 8 shows a flowchart of an additional process executed by a coordinator system, according to an embodiment of the invention. Process 800 begins with a processor (e.g., of coordinator system 120) receiving 802 a request from a client device (e.g., computing device 100). The request may be a request for a training task, as described above with reference to FIGS. 3 and 7. The processor, in response to receiving the request, transmits 804 a machine learning model and training data to the client device. For example, the processor retrieves a task from task queue 150 (e.g., using task queue manager 330).

The processor receives 806 a trained version of the machine learning model (e.g., in accordance with the task). A nonce may be generated as a byproduct of the trained version (e.g., based on an error value associated with how well the machine learning model is trained). The processor, in response to receiving the trained version, determines 808 whether the trained version of the machine learning model satisfies an acceptance criterion (e.g., based on predictive data, as described above). The processor, in response to determining that the trained version of the machine learning model satisfies the acceptance criterion, causes 810 release of a token to a user of the client device (e.g., a stake associated with completion of the task).

Alternative Applications

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for:
receiving a request from a client device;
in response to receiving the request, transmitting a machine learning model and training data to the client device;
receiving a trained version of the machine learning model, wherein a nonce is generated as a byproduct of the trained version, the nonce being at least a part of a candidate value for a new block being added to a blockchain;
in response to receiving the trained version, determining whether the trained version of the machine learning model satisfies an acceptance criterion; and
in response to determining that the trained version of the machine learning model satisfies the acceptance criterion, causing release of a token to a user of the client device.

2. The method of claim 1, wherein determining whether the trained version of the machine learning model satisfies the acceptance criterion comprises:
predicting results for the set of training data;
determining a first aggregate value based on the predicted results;
determining a second aggregate value based on results of the trained version of the machine learning model;
determining an error value based on a difference between the first aggregate value and the second aggregate value; and
determining that the trained version of the machine learning model satisfies the acceptance criterion based on whether the error value is less than an error threshold value.

3. The method of claim 2, further comprising:
transmitting the error value to the client device with instructions to use the error value to form the nonce, wherein the nonce causes the new block to be added to the blockchain based on a hash value generated by adding the nonce to a block that satisfies a predetermined criteria.

4. The method of claim 1, further comprising, in response to determining that the trained version of the machine learning model does not satisfy the acceptance criterion, preventing the release of the token to the user.

5. The method of claim 4, further comprising, further in response to determining that the trained version of the machine learning model does not satisfy the acceptance criterion:
transmitting an error value to the client device with instructions to use the error value to form the nonce, wherein the nonce causes the new block to be added to the blockchain based on a hash value generated by adding the nonce to a block that satisfies a predetermined criterion.

6. The method of claim 1, wherein the request is received by a coordinator system, and wherein the coordinator system assigns tasks to train additional machine learning models using additional training sets.

7. The method of claim 6, wherein the coordinator system is decentralized, and wherein management of the tasks is enforced by distributed data structures.

8. A system comprising a processor configured to:
receive a request from a client device;
in response to receiving the request, transmit a machine learning model and training data to the client device;
receive a trained version of the machine learning model, wherein a nonce is generated as a byproduct of the trained version, the nonce being at least a part of a candidate value for a new block being added to a blockchain;
in response to receiving the trained version, determine whether the trained version of the machine learning model satisfies an acceptance criterion; and
in response to determining that the trained version of the machine learning model satisfies the acceptance criterion, cause release of a token to a user of the client device.

9. The system of claim 8, wherein the processor is further configured, when determining whether the trained version of the machine learning model satisfies the acceptance criterion, to:
predict results for the set of training data;
determine a first aggregate value based on the predicted results;
determine a second aggregate value based on results of the trained version of the machine learning model;
determine an error value based on a difference between the first aggregate value and the second aggregate value; and
determine that the trained version of the machine learning model satisfies the acceptance criterion based on whether the error value is less than an error threshold value.

10. The system of claim 9, wherein the processor is further configured to:
transmit the error value to the client device with instructions to use the error value to form the nonce, wherein the nonce causes the new block to be added to the blockchain based on a hash value generated by adding the nonce to a block that satisfies a predetermined criteria.

11. The system of claim 8, wherein the processor is further configured to, in response to determining that the trained version of the machine learning model does not satisfy the acceptance criterion, prevent the release of the token to the user.

12. The system of claim 11, wherein the processor is further configured to, further in response to determining that the trained version of the machine learning model does not satisfy the acceptance criterion:
transmit an error value to the client device with instructions to use the error value to form the nonce, wherein the nonce causes the new block to be added to the blockchain based on a hash value generated by adding the nonce to a block that satisfies a predetermined criterion.

13. The system of claim 8, wherein the processor is part of a coordinator system, and wherein the coordinator system assigns tasks to train additional machine learning models using additional training sets.

14. The system of claim 13, wherein the coordinator system is decentralized, and wherein management of the tasks is enforced by distributed data structures.

15. A non-transitory computer readable medium configured to store instructions, the instructions when executed by a processor cause the processor to:
receive a request from a client device;
in response to receiving the request, transmit a machine learning model and training data to the client device;
receive a trained version of the machine learning model, wherein a nonce is generated as a byproduct of the trained version, the nonce being at least a part of a candidate value for a new block being added to a blockchain;
in response to receiving the trained version, determine whether the trained version of the machine learning model satisfies an acceptance criterion; and
in response to determining that the trained version of the machine learning model satisfies the acceptance criterion, cause release of a token to a user of the client device.

16. The non-transitory computer readable medium of claim 15, wherein the instructions, when executed by the processor, further cause the processor, when determining whether the trained version of the machine learning model satisfies the acceptance criterion, to:
predict results for the set of training data;
determine a first aggregate value based on the predicted results;
determine a second aggregate value based on results of the trained version of the machine learning model;
determine an error value based on a difference between the first aggregate value and the second aggregate value; and
determine that the trained version of the machine learning model satisfies the acceptance criterion based on whether the error value is less than an error threshold value.

17. The non-transitory computer readable medium of claim 16, wherein the instructions, when executed by the processor, further cause the processor to:
transmit the error value to the client device with instructions to use the error value to form the nonce, wherein the nonce causes the new block to be added to the blockchain based on a hash value generated by adding the nonce to a block that satisfies a predetermined criteria.

18. The non-transitory computer readable medium of claim 15, wherein the instructions, when executed by the processor, further cause the processor to, in response to determining that the trained version of the machine learning model does not satisfy the acceptance criterion, prevent the release of the token to the user.

19. The non-transitory computer readable medium of claim 18, wherein the instructions, when executed by the processor, further cause the processor, further in response to determining that the trained version of the machine learning model does not satisfy the acceptance criterion, to:
transmit an error value to the client device with instructions to use the error value to form the nonce, wherein the nonce causes the new block to be added to the blockchain based on a hash value generated by adding the nonce to a block that satisfies a predetermined criterion.

20. The non-transitory computer readable medium of claim 15, wherein the processor is part of a coordinator system, wherein the coordinator system assigns tasks to train additional machine learning models using additional training sets, wherein the coordinator system is decentralized, and wherein management of the tasks is enforced by distributed data structures.
